(19) United States
(12) Patent Application Publication
(10) Pub. No.: US 2023/0359169 A1
(43) Pub. Date: Nov. 9, 2023

(54) 3D PRINTER PART PACKING

(71) Applicants: Hewlett-Packard Development Company, L.P., Spring, TX (US); Instituto Atlântico, Edson Queiroz, Fortaleza (BR)

(72) Inventors: Scott Alan WHITE, Boise, ID (US); Alyne GOMES SOARES CANTAL, Porto Alegre (BR); Juan Carlos CATANA SALAZAR, San Diego, CA (US); Jun Zeng, Palo Alto, CA (US)

(21) Appl. No.: 18/029,217

(22) PCT Filed: Sep. 29, 2020
(86) PCT No.: PCT/US2020/053337

§ 371 Date: Mar. 29, 2023

(51) Int. Cl. G05B 19/4099

(52) U.S. Cl. CPC G05B 19/4099; G05B 2219/49023

(57) ABSTRACT

An example non-transitory computer-readable medium includes instructions that, when executed by a processor, cause the processor to retrieve a plurality of parts to be three-dimensionally (3D) printed and an output rate indicative of a rate at which previous 3D printed parts have been output, select a packing parameter that results in a packing time corresponding to the output rate, and compute a part packing of the plurality of parts for a print bed according to the packing parameter.

### BACKGROUND

Additive manufacturing is a technique to form three-dimensional (3D) objects by adding material until the object is formed. The material may be added by forming several layers of material with each layer stacked on top of the previous layer. Additive manufacturing is also referred to as 3D printing. Examples of 3D printing include melting a filament to form each layer of the 3D object (e.g., fused filament fabrication), curing a resin to form each layer of the 3D object (e.g., stereolithography), sintering, melting, or binding powder to form each layer of the 3D object (e.g., selective laser sintering or melting, multi jet fusion, metal jet fusion, etc.), and binding sheets of material to form the 3D object (e.g., laminated object manufacturing, etc.).

Some additive manufacturing techniques may be able to form more than one object at the same time. For example, a 3D printer may form a part out of layers and may be able to form layers of multiple parts at the same time. The number of parts that can be formed at the same time may depend on the size of the 3D printer, such as the size of a print bed of the 3D printer, and how the parts are arranged in the print bed. Arranging a set of parts so that they fit within the size of a print bed may be referred to as part packing.

### BRIEF DESCRIPTION OF THE DRAWINGS

FIG. 1 is a block diagram of an example system to pack parts for 3D printing.

FIG. 2 is a block diagram of another example system to pack parts for 3D printing.

FIG. 3 is a flow diagram of an example method to pack parts for 3D printing.

FIG. 4 is a flow diagram of another example method to pack parts for 3D printing.

FIG. 5 is a block diagram of an example computer-readable medium including instructions that cause a processor to pack parts for 3D printing.

FIG. 6 is a block diagram of another example computer-readable medium including instructions that cause a processor to pack parts for 3D printing.

### DETAILED DESCRIPTION

Three-dimensional (3D) printers may be used for manufacturing. For example, the 3D printers may be used to produce final products, to produce parts that will be integrated into final products, to produce molds, or the like. In a manufacturing environment, the 3D printers may be part of a workflow that includes various operations that are performed. The various operations may be interrelated with some operations being dependent on completion of other operations in the workflow. Some operations may be performed prior to 3D printing, such as receiving orders and corresponding design files, engineering to correct defects in design files, verifying that design files can be printed, sequencing orders based on priority, packing design files into print beds for printing, etc. Other operations may be performed after 3D printing, such as post processing, quality assurance, additional assembly or molding operations, packaging, shipping, etc. Whereas many of the operations performed prior to 3D printing are performed in the digital realm (e.g., involve the manipulation data), the operations performed after 3D printer are often performed on physical objects.

A manufacturer may wish to maximize productivity of their manufacturing operation. To do so, the manufacturer may configure the workflow to maximize the number of final products produced for a particular set of inputs. In a manufacturing environment, the productivity of operations on physical objects are at their most efficient when production flow is smooth. When production falls, manufacturing capacity may be left idle, decreasing productivity. When production rises, there may be additional labor and storage costs to manage the excess production. In a manufacturing environment with 3D printers, the 3D printers contribute to a smooth production flow when parts are produced by the 3D printers at approximately a constant rate, and the 3D printers disrupt a smooth production flow when the rate of part production varies significantly over time scales of days or weeks.

Unfortunately, there are a number of factors that work against the 3D printers being able to produce parts at an approximately constant rate. First, the demand may be stochastic. Orders may arrive in bursts or otherwise vary significantly over time scales of days or weeks. Second, production capacity may vary over time. 3D printers, post-processing machines, or other equipment may fail, may need maintenance, or have other variations in their productive capacity. As a result of the variations in demand and in productive capacity, the production flow may be very volatile, which may result in decreased productivity. Accordingly, manufacturing productivity for workflows involving 3D printers could be improved by smoothing the production flow.

3D printers also face the issue of how to pack parts for printing. The cost per part may be proportional to how densely the parts are packed into the print bed. However, part packing is a nondeterministic polynomial (NP-) complete problem. For example, the size of the solution space (e.g., number of possible packing arrangements) for placement of parts (without rotation, for example) in a relatively small batch of 20 objects, is beyond the order of 1×10¹⁸. Thus, there is a tradeoff between time and cost per part. The cost per part can be reduced by spending more time searching the solution space for an optimal part packing, or time can be saved by terminating the search early despite having a non-optimal part packing that results in a higher cost per part. Part packing for 3D printers could be improved by better managing the trade off between packing time and cost per part.

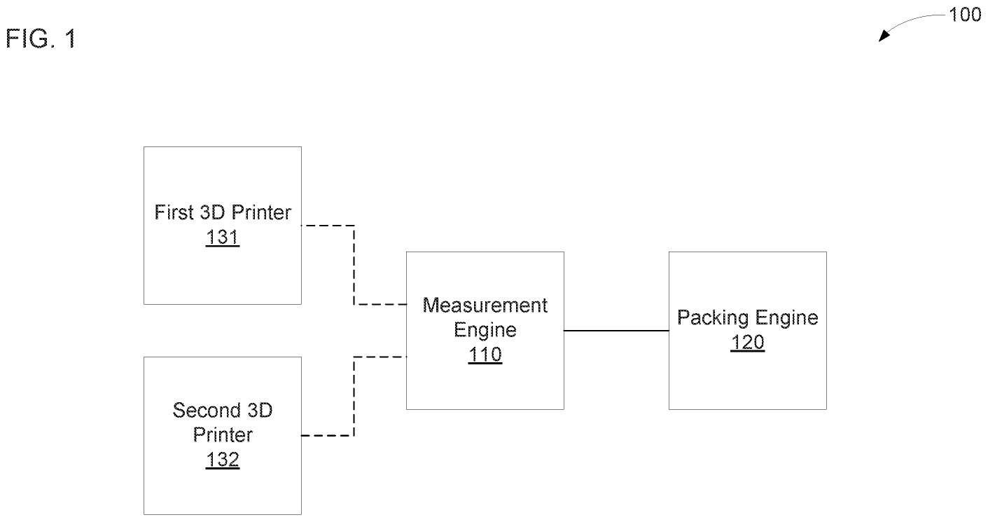

FIG. 1 is a block diagram of an example system 100 to pack parts for 3D printing. The system 100 may include a plurality of 3D printers, including a first 3D printer 131 and a second 3D printer 132, to generate printed parts. For example, the 3D printers 131, 132 may receive part packings and generate the printed parts based on the part packings. As used herein, the term “part packing” refers to an indication of how parts should be arranged in a print bed. For example, the part packing may be data, such as a design file composed of individual deign files arranged according to the intended physical arrangement, a set of layer data to produce the printed parts in the intended physical arrangement, or the like. A part packing may also be referred to as a build bucket or a bucket of parts. The term “printed part” refers to an object produced by a 3D printer.

The system 100 may include a measurement engine 110. As used herein, the term “engine” refers to hardware (e.g., analog or digital circuitry, a processor, such as an integrated circuit, or other circuitry) or a combination of software (e.g., programming such as machine- or processor-executable instructions, commands, or code such as firmware, a device driver, programming, object code, etc.) and hardware. Hardware includes a hardware element with no software elements such as an application specific integrated circuit (ASIC), a Field Programmable Gate Array (FPGA), etc. A combination of hardware and software includes software hosted at hardware (e.g., a software module that is stored at a processor-readable memory such as random-access memory (RAM), a hard-disk or solid-state drive, resistive memory, or optical media such as a digital versatile disc (DVD), and/or executed or interpreted by a processor), or hardware and software hosted at hardware. The measurement engine 110 may determine a rate at which the printed parts are output. For example, various computer systems may track as operations from a workflow are performed on the printed parts. The measurement engine 110 may communicate with a computer system or several of the computer systems to determine where the printed parts are in the workflow. Based on the locations of the printed parts within the workflow, the measurement engine 110 may determine the rate at which the printed parts are output, for example, from a particular stage in the workflow. The measurement engine 110 may determine the rate as a number of printed parts output over a fixed period of time.

The system 100 may include a packing engine 120. The packing engine 120 may select a packing parameter that results in a packing time corresponding to the rate at which the printed parts are output. For example, the measurement engine 110 may communicate the rate it determined to the packing engine 120. The packing engine 120 may determine the packing time based on the rate and the number of parts that can be packed into a part packing. The packing engine 120 may store an indication of the relationship between the packing parameter and the packing time. For example, the packing engine 120 may retrieve a stored equation, table, or the like that relates packing times to values of the packing parameter. The packing engine 120 may select the packing parameter based on the packing time to be achieved.

The packing engine 120 may compute a part packing of a plurality of parts for a print bed according to the packing parameter. For example, the packing engine 120 may employ a strategy to search the solution space of possible part packings for a candidate solution that scores best according to a criterion. The criterion may include minimizing the volume of the part packing, maximizing the number of parts in the part packing, minimizing a height in the z-direction of the part packing, or the like. As used herein, the term “z-direction” refers to a direction parallel to the direction of the force of gravity acting on a 3D printer. The packing parameter may affect how the packing engine 120 searches the solution space, for example, by affecting how much of the solution space is searched. The packing engine 120 may search the solution space in the manner dictated by the packing parameter.

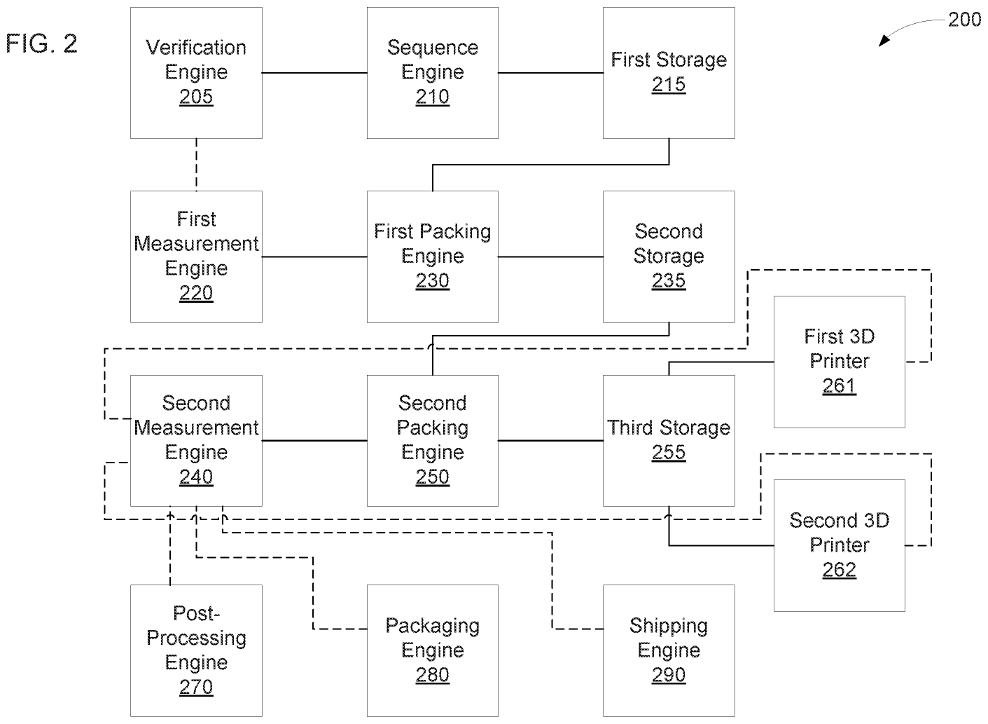

FIG. 2 is a block diagram of another example system 200 to pack parts for 3D printing. The system 200 may include a verification engine 205. The verification engine 205 may receive part orders and verify a design file associated with each part order is printable. The verification engine 205 may receive part orders from external customers, internal users or systems, or the like. The part orders may include new part orders received for a first time, orders to re-print parts that failed to be manufactured properly (e.g., failed to print properly), or the like. Part orders that are not printable may be returned to the person or entity submitting the part order or may be provided to another system or user for correction. The verification engine 205 may verify that part orders are printable by verifying that the design file is water-tight.

The system 200 may include a sequence engine 210. The sequence engine 210 may generate a list of parts from the plurality of part orders. The sequence engine 210 may order the list according to a priority of the parts in the list. For example, the sequence engine 210 may prioritize the parts based on expected or request shipping date/time, date/time of order receipt or order acceptance, current time, expected production time, etc. The sequence engine 210 may determine the expected production time based on the historical experience of similar jobs. The sequence engine 210 may group together parts that should be printed together. Such a group of parts may include parts that will be assembled together, parts that will be shipped to the same customer, or the like. The sequence engine 210 may assign a single priority to a set of grouped parts.

The system 200 may include a first storage 215. As used herein, the term “storage” refers to a non-transitory computer-readable medium or a portion of a non-transitory computer-readable medium. For example, a single non-transitory computer-readable medium may include multiple storages. The storage may be volatile or non-volatile. The first storage 215 may store the list of parts generated by the sequence engine 210. In some examples, the first storage 215 may store the list of parts as a single queue arranged by priority. In some examples, the first storage 215 may partition the parts into multiple groups. The size of each group may be selected so that all parts in each group can be packed into a single part packing. The size may be the number of parts, the volume of parts, or the like. The size may be determined based on the number and volume of parts or the average volume of parts. For example, a smaller total part volume may fit when the number of parts is larger. Accordingly, the number of parts included in each group may be the maximum possible volume for a part packing divided by the average volume of the parts, the maximum possible volume for a part packing divided by a multiple of the average volume of the parts, the maximum possible volume for a part packing divided by the average volume of the parts raised to an exponent, or the like. Groups may be used in examples where the volume in which parts are being packed does not vary (e.g., print beds are a consistent size).

The system 200 may include a first measurement engine 220. The first measurement engine 220 may determine a rate at which a plurality of part orders is received. For example, the first measurement engine 220 may determine the rate at which the verification engine 205 receives orders, the rate at which verified orders are received from the verification engine 205, or the like. The verification engine 205 may store information about orders that are received or that are verified, such as a date/time of receipt or verification. The first measurement engine 220 may access the stored information about the orders. The first measurement engine 220 may determine the rate at which orders are received by counting how many orders were received over a particular time period, such as 12 hours, 24 hours, two days, one week, or the like.

The system may include a first packing engine 230. The first packing engine 230 may select a packing parameter for the first packing engine that results in a packing time for the first packing engine corresponding to the rate at which the plurality of part orders is received. The first packing engine 230 also may compute a first part packing of a plurality of parts for the print bed according to the packing parameter for the first packing engine. The first packing engine 230 may employ meta-heuristic optimization approaches, such as evolutionary or genetic approaches, simulated annealing, particle swarm optimization, Monte Carlo approaches, heuristic rules, or the like to compute several part packings and may select the part packing that scores best according to a criterion (e.g., minimizing the volume of the part packing, maximizing the number of parts in the part packing, minimizing a height in the z-direction of the part packing, or the like). The evolutionary approaches may generate a set of candidate packing solutions for an initial generation. For each future generation, a new set of candidate packing solutions may be generated based on aspects of the best scoring candidate packing solutions from previous generations and based on incorporating random variations. Example rules or heuristics may include packing in order of largest part to smallest, orienting parts so major or minor axes are parallel, packing smaller groups of parts into portions of the print bed (e.g., starting at a bottom portion), or the like. The first packing engine 230 may obey rules relating to print process constraints regardless of the technique used for packing. For example, the first packing engine 230 may maintain a minimum inter-part spacing between parts, which may vary depending on part geometry.

To select the packing parameter, the first packing engine 230 may determine a packing time. The packing time is the amount of time spent generating part packing. For example, the packing time may be the amount of time spent exploring the solution space before selecting a best scoring candidate solution. The first packing engine 230 may select a packing time that will result in the rate at which parts are output from the first packing engine 230 equaling the rate at which part orders are received. The rate at which parts are output from the first packing engine 230 may be the number of parts included in part packings over a particular period of time divided by the length of the period of time. Accordingly, the packing time may equal the number of parts included in each part packing multiplied by the number of part packings being generated in parallel (e.g., the first packing engine 230 may compute multiple packings in parallel or there may be multiple first packing engines) divided by the rate at which part orders are received. The first packing engine 230 may receive an indication of the rate at which part orders are received from the first measurement engine 220. The number of parts that can be included in each part packing may be estimated or computed based on the average volume of a set of parts, the total volume of the set, etc. in any of the manners previously discussed. In some examples, the first packing engine 230 may select a packing time that results in the output rate from the first packing engine 230 approximately equaling or being slightly greater than the rate at which part orders are received. As used herein, the terms “approximately” and “slightly” refer to a value that is within 0.5%, 1%, 2%, 5%, 10%, etc. of another value.

The packing parameter may be a population size for an evolutionary approach (e.g., the number of candidate solutions included in each generation), a number of generations in an evolutionary approach, a size of snap points (e.g., the number of possible positions or orientations in which parts can be placed), a resolution (e.g., a voxel size used to represent the parts), or the like. The first packing engine 230 may store an indication of the relationship between packing time and the packing parameter. For example, the first packing engine 230 may retrieve a stored equation, table, or the like that relates packing times to values of the packing parameter. The equation, table, etc. may take a packing time as an input and output a value of the packing parameter. The first packing engine 230 may calculate the value of the packing parameter from the packing time and the equation, table, etc. accordingly. The first packing engine 230 may dynamically adjust the packing parameter or number of packings performed in parallel as the rate at which part orders are received changes over time. For example, the first packing engine 230 may update the packing parameter every 12 hours, 24 hours, two days, one week, etc.

The first packing engine 230 may select a plurality of parts from the first storage 215 (e.g., from the prioritized list of parts). The first packing engine 230 may select the parts based on their priority. For example, the parts may be ordered based on priority, and the first packing engine 230 may select a portion of the list including the highest priority items. Larger numbers may indicate higher priority, or smaller numbers may indicate higher priority. Accordingly, selecting the highest priority can include selecting maximum or minimum values indicative of priority. In some examples, the first packing engine 230 may retrieve the entire list and attempt to pack the parts in order of priority. If a large part in the list is unlikely to fit in the part packing, the first packing engine 230 may skip the large part and select a smaller part further down the list. The first packing engine 230 may return to the list any parts that it was unable to fit in the part packing. In examples in which the first storage 215 includes multiple groups, the first packing engine 230 may select a highest priority group. The first packing engine 230 may process a set of highest priority groups in examples with packing performed in parallel. The first packing engine 230 may execute the part packing technique on a plurality of parts from the first storage using the packing parameter that it selected to generate a first part packing.

The system 200 may include a second storage 235. The first packing engine 230 may store the first part packing in the second storage 235 along with other part packings. The second storage 235 may act as a buffer that fills when the rate at which part orders are received exceeds the rate at which printed parts are output and that empties when the rate at which printed parts are output exceeds the rate at which part orders are received. Each part packing or each part in the part packings may be associated with a priority. Indications of the priorities may also be stored in the second storage.

The system 200 may include a second measurement engine 240. The second measurement engine 240 may determine a rate at which printed parts are output. In the illustrated example, the second measurement engine 240 is communicatively coupled to first and second 3D printers 261, 262, a post-processing engine 270, a packaging engine 280, and a shipping engine 290. In other examples, the second measurement engine 240 may be coupled to more or fewer system. For example, the measurement engine 240 may be coupled to engines to track assembly, molding based on the 3D printed parts, or the like. For example, the second measurement engine 240 may be coupled to a single system or a single group of systems and determine the rate at which printed parts are output from the single system or single group of systems. In some examples, the second measurement engine 240 may measure the rate at which printed parts are output by measuring the rate at which printed parts are generated by the 3D printers 261, 262, the rate at which printed parts are shipped, the rate at which printed parts are output from a bottleneck, or the like. The second measurement engine 240 may measure the rate at parts formed from the 3D printed parts are output (e.g., the rate at which parts assembled from the 3D printed parts are output, the rate at which parts molded from the 3D printed parts are output, etc.).

The 3D printers 261, 262, post-processing engine 270, packaging engine 280, or the shipping engine 290 may store information about which parts were printed, post-processed, packaged, or shipped and the date/time at which the action was taken on the part. Users may scan identifiers (e.g., barcodes, QR codes, etc.) on the parts, manually type the identifiers into the engines, or the like as actions are taken on the parts. For example, before, while, or after the user has post-processed, packaged, or shipped the printed parts, the user may indicate to the post-processing engine 270, packaging engine 280, or shipping engine 290 that the user is performing that particular action on the printed part. The post-processing engine 270, packaging engine 280, or shipping engine 290 may update stored records to reflect that the action was taken and the date/time at which the action was taken. The 3D printers 261, 262 may store information about which parts are being printed or have been printed and may store a date/time that the parts were printed. The second measurement engine 240 may access the stored information and determine the rate at which printed parts are output by counting how many printed parts were acted upon or generated over a particular time period, such as 12 hours, 24 hours, two days, one week, or the like.

The system 200 may include a second packing engine 250. In some instances, the second packing engine 250 may be able to improve on the first part packing by further searching the solution space. The second packing engine 250 may select a packing parameter for the second packing engine 250 that results in a packing time corresponding to the rate at which the printed parts are output. The second packing engine 250 may compute a second part packing of the plurality of parts in the first part packing according to the packing parameter for the second packing engine 250. The second packing engine 250 may employ meta-heuristic optimization approaches, such as evolutionary or genetic approaches, simulated annealing, particle swarm optimization, Monte Carlo approaches, heuristic rules, or the like to compute several part packings and may select the part packing that scores best according to a criterion (e.g., minimizing the volume of the part packing, maximizing the number of parts in the part packing, minimizing a height in the z-direction of the part packing, or the like). For example, the second packing engine 250 may employ any of the techniques previously discussed and may use the same technique as the first packing engine 230 or a different technique. The second packing engine 250 may obey rules relating to print process constraints.

The second packing engine 250 may determine a packing time that will result in a rate at which parts are output from the second packing engine equaling, approximately equaling, or being slightly greater than the rate at which printed parts are output. For the second packing engine 250, the packing time may equal, approximately equal, or be slightly greater than the number of parts included in each part packing multiplied by the number of part packings being generated in parallel (e.g., the second packing engine 250 may compute multiple packings in parallel or there may be multiple second packing engines) divided by the rate at which printed parts are output. The second packing engine 250 may receive an indication of the rate at which printed parts are output from the second measurement engine 240. The number of parts that will be included in each part packing may be known from the first part packings.

The packing parameter may be a population size, a number of generations, a size of snap points, a resolution, or the like. The second packing engine 250 may store an indication of the relationship between packing time and the packing parameter. The first and second packing engines 230, 250 may each store indications of the relationships or may store a jointly accessible indication of the relationship. The indication of the relationship may be an equation, a table, or the like as previously discussed. The second packing engine 250 may dynamically adjust the packing parameter or number of packings performed in parallel as the rate at which part orders are received changes over time. For example, the second packing engine 250 may update the packing parameter every 12 hours, 24 hours, two days, one week, etc.

The second packing engine 250 may select a first part packing from the second storage 235. The second packing engine 250 may select the first part packing based on priority, for example, by choosing a first part packing associated with a highest priority, by choosing a first part packing that includes a highest priority part, by choosing a first part packing with highest average or median priority, or the like. The second packing engine 250 may execute the part packing technique on the parts in the first part packing using the packing parameter that it selected to generate a second part packing. The second packing engine 250 may compare the first part packing to the second part packing and select the better part packing (e.g., the part packing with higher score according to a criterion) to ensure the output from the second packing engine 250 is no worse than the input. For example, the criterion for the second packing engine 250 may be a height in the z-direction. Reducing the height in the z-direction may reduce the print time for the part packing. The second packing engine 250 may compare the height in the z-direction of the first part packing and the second part packing to decide which is better.

The system 200 may include a third storage 255. The second packing engine 250 may store the better of the first and second part packings in the third storage 255. The part packings stored in the third storage 255 may be ordered based on the priority of each of the part packings (e.g., priorities associated with the part packings, priorities associated with the parts in the part packings, or the like). For example, the third storage 255 may store the part packings as a queue ordered based on priority. The first part packing in the queue may be the part packing with the highest priority, the part packing including the highest priority part, the part packing having parts with the highest average or median priority, or the like.

The system 200 may include a first 3D printer 261 and a second 3D printer 262. Although two 3D printers are included in the illustrated example, other examples may include additional 3D printers, such as dozens of 3D printers. The 3D printers may include fused filament fabrication printers, laminated object manufacturing printers, stereolithography printers, selective laser sintering printers, multi jet fusion printers, selective laser melting printers, metal jet fusion printers, or the like. The 3D printers 261, 262 may generate printed parts according to the part packings. For example, the part packings may be used to generate layer data, contone maps, or the like that are used to form the parts included in the part packings. During printing, the parts may be produced in the print beds of the 3D printers 261, 262 in the arrangement that is indicated by the part packing. Each 3D printer 261, 262 may select a part packing based on the order of the part packings in the third storage 255 and may print the selected part packing. For example, each 3D printer 261, 262 may select the first part packing in the queue (e.g., the highest priority part packing) and print that part packing. In examples with multiple types of printers, each 3D printer 261, 262 may select the first part packing in the queue that it is capable of printing. The 3D printers 261, 262 may print the parts included in the selected part packing in the arrangement indicated by the part packing. The system 200 may produce a smooth flow of printed parts that are generated at a steady rate. The steady rate may correspond to the rate at which printed parts can be processed down stream of the 3D printers. The steady rate may allow for an efficient workflow that increases productivity relative to printing that produces parts at a varying rate.

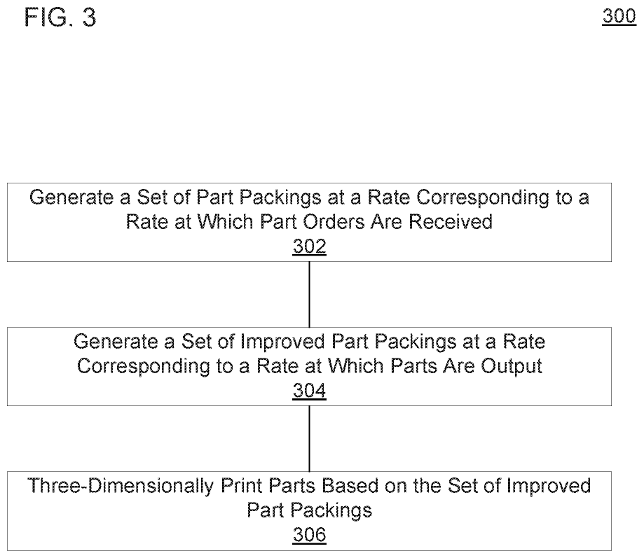

FIG. 3 is a flow diagram of an example method 300 to pack parts for 3D printing. A processor may perform elements of the method 300. For illustrative purposes, the method 300 is described in connection with the device of FIG. 2. However, other devices may perform the method in other examples. At block 302, the method 300 may include generating a set of part packings that each include a plurality of parts at a rate corresponding to a rate at which part orders are received. For example, the first packing engine 230 may generate the set of part packings in any of the manners previously discussed.

Block 304 may include generating a set of improved part packings based on the set of part packings at a rate corresponding to a rate at which parts are output. For example, the second packing engine 250 may generate the set of improved part packings in any of the manners previously discussed. At block 306, the method 300 may include 3D printing parts based on the set of improved part packings. For example, the first or second 3D printers 261, 262 may print the parts in any of the manners previously discussed.

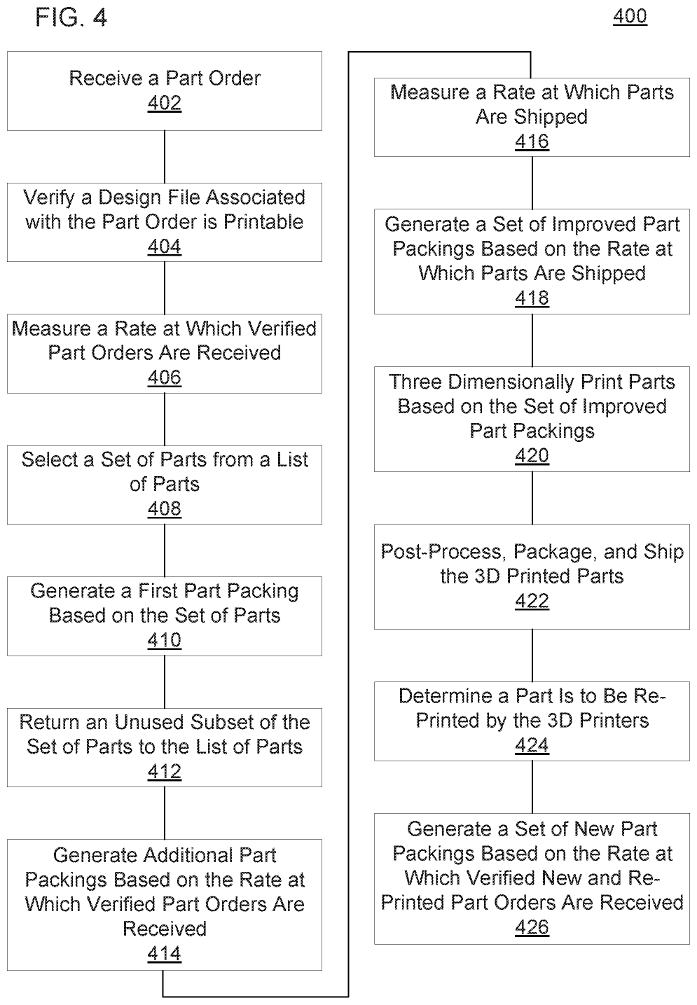

FIG. 4 is a flow diagram of another example method 400 to pack parts for 3D printing. A processor may perform elements of the method 400. For illustrative purposes, the method 400 is described in connection with the device of FIG. 2. However, other devices may perform the method in other examples. Block 402 may include receiving a part order, and block 404 may include verifying a design file associated with the part order is printable. For example, the verification engine 205 may receive the part order and verify the design file in any of the manners previously discussed.

At block 406, the method 400 may include measuring a rate at which verified part orders are received. For example, the first measurement engine 220 may measure the rate at which verified part orders are received in any of the manners previously discussed. Block 408 may include selecting a set of parts from a list of parts, block 410 may include generating a first part packing based on the set of parts (e.g., at a rate corresponding to a rate at which verified part orders are received), and block 412 may include returning an unused subset of the set of parts that was not included in the first part packing to the list of parts. Block 414 may include generating additional part packings that each include a plurality of parts at a rate corresponding to a rate at which verified part orders are received. In some examples, the first packing engine 230 may select the set of parts, generate the first part packing and the additional part packings, and return the unused subset of parts in any of the manners previously discussed.

At block 416, the method 400 may include measuring, with a processor, a rate at which parts are shipped. For example, the shipping engine 290 may track parts that are shipped, and the second measurement engine 240 may communicate with the shipping engine 240 to measure the rate at which parts are shipped in any of the manners previously discussed. Block 418 may include generating a set of improved part packings based on the set of part packings (e.g., the first part packing and the additional part packings) at a rate corresponding to a rate at which parts are output. For example, the second packing engine 250 may generate the set of improved part packings in any of the manners previously discussed.

At block 420, the method 400 may include 3D printing parts based on the set of improved part packings. For example, the first and second 3D printers 261, 262 may print parts based on the part packings in any of the manners previously discussed. Block 422 may include post-processing, packaging, and shipping the 3D printed parts. For example, a person or robot may perform the post-processing, packaging, and shipping. Post-processing may include removing parts from the 3D printers 261, 262, removing powder from the parts, applying energy or chemicals to change a finish of the printed parts, or the like. The post-processed parts may be assembled with other parts (e.g., printed or non-printed parts), may be used as molds to form additional parts, or the like. Packaging may include surrounding the printed part (or a part formed from the printed part) in a cushioning material and placing the printed part (or a part formed from the printed part) in a container. Shipping may include adding labeling or postage to the container and providing the container to an entity that will transport the container. In some examples, information about the post-processing, packaging, or shipping may be stored by a user or robot in the post-processing engine 270, the packaging engine 280, or the shipping engine 290.

At block 424, the method 400 may include determining a part is to be re-printed by the 3D printers. For example, the 3D printers 261, 262, post-processing engine 270, packaging engine 280, or shipping engine 290 may determine that a part failed to print or was damaged or failed after printing. The verification engine 205 may receive an indication that the part is to be re-printed from the device that determined the failure occurred and may process it accordingly in any of the manners previously discussed. Block 426 may include generating a set of new part packings that include the part to be re-printed and a plurality of new parts at a rate corresponding to a rate at which new part orders and re-printed part orders are received. For example, the first measurement engine 220 may determine the rate at which new part orders and re-printed part orders are received in any of the manners previously discussed. The first packing engine 230 may generate the set of new part packings in any of the manners previously discussed.

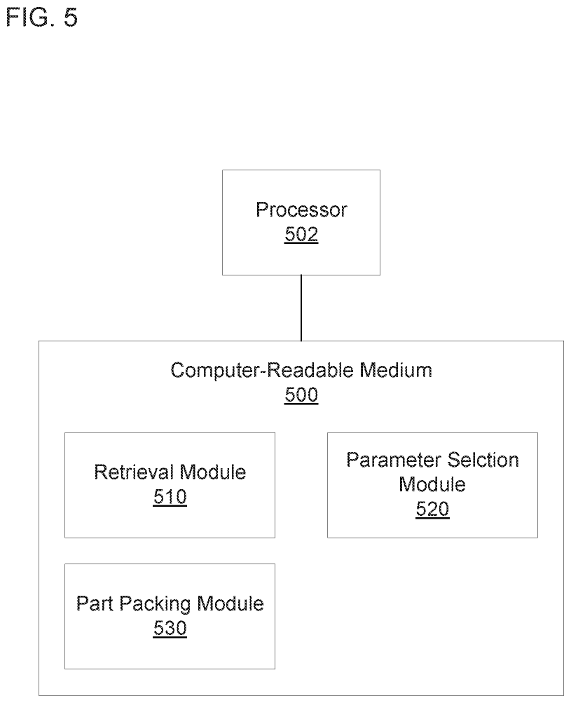

FIG. 5 is a block diagram of an example computer-readable medium 500 including instructions that, when executed by a processor 502, cause the processor 502 to pack parts for 3D printing. The computer-readable medium 500 may be a non-transitory computer-readable medium, such as a volatile computer-readable medium (e.g., volatile RAM, a processor cache, a processor register, etc.), a non-volatile computer-readable medium (e.g., a magnetic storage device, an optical storage device, a paper storage device, flash memory, read-only memory, non-volatile RAM, etc.), and/or the like. The processor 502 may be a general-purpose processor or special purpose logic, such as a microprocessor (e.g., a central processing unit, a graphics processing unit, etc.), a digital signal processor, a microcontroller, an ASIC, an FPGA, a programmable array logic (PAL), a programmable logic array (PLA), a programmable logic device (PLD), etc.

The computer-readable medium 500 may include a retrieval module 510, a parameter selection module 520, and a part packing module 530. As used herein, a “module” (in some examples referred to as a “software module”) is a set of instructions that when executed or interpreted by a processor or stored at a processor-readable medium realizes a component or performs a method. The retrieval module 510 may include instructions that, when executed, cause the processor 502 to retrieve a plurality of parts to be 3D printed and an output rate indicative of a rate at which previous 3D printed parts have been output. In some examples, the retrieval module 510 may implement the packing engine 120 when executed and may retrieve the plurality of parts in any of the manners previously discussed (e.g., by retrieving an existing part packing, retrieving a group of parts, retrieving parts from an ordered list or queue, etc.).

The parameter selection module 520 may cause the processor 502 to select a packing parameter that results in a packing time corresponding to the output rate. In some examples, the parameter selection module 520 may implement the packing engine 120 when executed and may select the packing parameter in any of the manners previously discussed. The part packing module 530 may cause the processor 502 to compute a part packing of the plurality of parts for a print bed according to the packing parameter. In some examples, the part packing module 530 may implement the packing engine 120 when executed and may compute the part packing in any of the manners previously discussed.

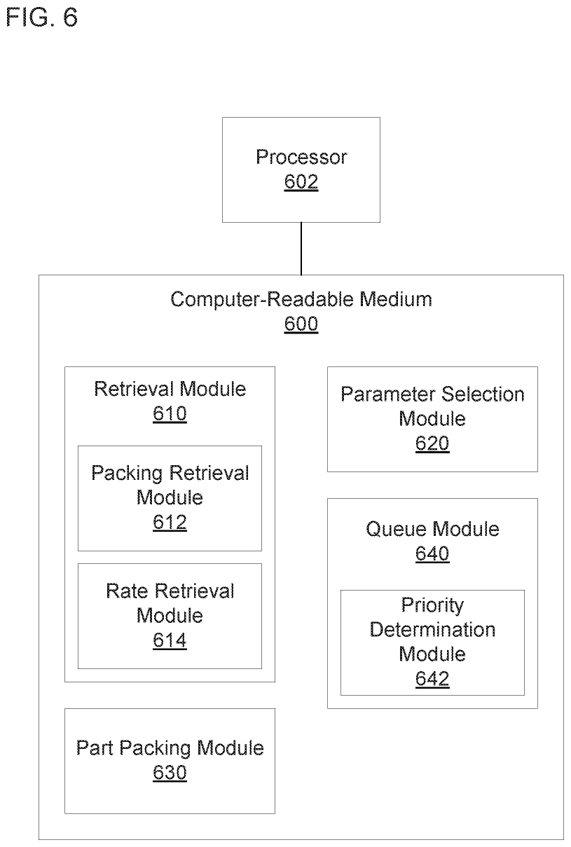

FIG. 6 is a block diagram of another example computer-readable medium 600 including instructions that, when executed by a processor 602, cause the processor 602 to pack parts for 3D printing. The computer-readable medium 600 may include a retrieval module 610, a packing retrieval module 612, a rate retrieval module 614, a parameter selection module 620, a part packing module 630, a queue module 640, and a priority determination module 642. The retrieval module 610 may include instructions that, when executed, cause the processor 602 to retrieve a plurality of parts to be 3D printed and an output rate indicative of a rate at which previous 3D printed parts have been output. For example, the retrieval module 610 may include the packing retrieval module 612 and the rate retrieval module 614. In some examples, the packing retrieval module 612 may cause the processor 602 to retrieve the plurality of parts by retrieving a part packing of the plurality of parts. The rate retrieval module 614 may cause the processor 602 to receive the rate or to determine the rate by accessing tracking data stored in another system. In some examples, the retrieval module 610 or the packing retrieval module 612 may implement the second packing engine 250 when executed and may retrieve the plurality of parts or the part packing in any of the manners previously discussed. The retrieval module 610 or the rate retrieval module 614 may implement the second measurement engine 240 or the second packing engine 250 and may retrieve or determine the rate in any of the manners previously discussed.

The parameter selection module 620 may cause the processor 602 to select a packing parameter that results in a packing time corresponding to the output rate. In some examples, the parameter selection module 620 may implement the second packing engine 250 when executed and may the packing parameter in any of the manners previously discussed. The part packing module 630 may cause the processor 602 to compute a part packing of the plurality of parts for a print bed according to the packing parameter. For example, the part packing module 630 may cause the processor 602 to compute the part packing by computing an improved part packing of the plurality of parts based on a retrieved part packing. The part packing module 630 may cause the processor 602 to compute the part packing in parallel with computations of a plurality of other part packings. For example, multiple instances of the part packing module 630 may be executed on the processor 602 (e.g., on a plurality of processors including the processor 602). In some examples, the part packing module 630 may implement the packing engine 250 when executed and may compute the part packing in any of the manners previously discussed.

The queue module 640 may cause the processor 602 to store the part packing in a queue at a location within the queue selected based on a priority of the part packing. The queue module 640 may include the priority determination module 642. The priority determination module 642 may cause the processor 602 to determine the priority of the part packing based on a priority of a part of the plurality of parts in the part packing. In some examples, the queue module 640 or the priority determination module 642 may implement the second packing engine 250 when executed and may determine the priority and store the part packing in any of the manners previously discussed, for example, by storing the part packing in the third storage 255.

The above description is illustrative of various principles and implementations of the present disclosure. Numerous variations and modifications to the examples described herein are envisioned. Accordingly, the scope of the present application should be determined only by the following claims.

What is claimed is:

1. A system comprising:
a plurality of three-dimensional (3D) printers to generate printed parts;
a measurement engine to determine a rate at which the printed parts are output; and
a packing engine to:
select a packing parameter that results in a packing time corresponding to the rate at which the printed parts are output, and
compute a part packing of a plurality of parts for a print bed according to the packing parameter.

2. The system of claim 1, wherein the measurement engine is a second measurement engine, the packing engine is a second packing engine, and the part packing is a second part packing, and wherein the system further comprises:
a first measurement engine to determine a rate at which a plurality of part orders is received; and
a first packing engine to:
select a packing parameter for the first packing engine that results in a packing time for the first packing engine corresponding to the rate at which the plurality of part orders is received, and
compute a first part packing of the plurality of parts for the print bed according to the packing parameter for the first packing engine.

3. The system of claim 2, further comprising a storage to store the first part packing, wherein the second packing engine is to obtain the first part packing from the storage, and wherein the second part packing is an improvement from the first part packing.

4. The system of claim 2, further comprising a sequence engine to generate a list of parts from the plurality of part orders, wherein the list is ordered according to a priority of the parts in the list, and wherein the first packing engine is to select the plurality of parts from the list.

5. The system of claim 1, further comprising a storage to store a plurality of part packings from the packing engine, wherein the storage is to order the plurality of part packings according to a priority of each of the plurality of part packings, and wherein each of the plurality of 3D printers is to select a part packing based on the order and print the selected part packing.

6. A method, comprising:
generating a set of part packings that each include a plurality of parts at a rate corresponding to a rate at which part orders are received;
generating a set of improved part packings based on the set of part packings at a rate corresponding to a rate at which parts are output; and
three-dimensionally (3D) printing parts based on the set of improved part packings.

7. The method of claim 6, further comprising post-processing, packaging, and shipping the 3D printed parts, and measuring, with a processor, a rate at which parts are shipped, wherein the rate at which parts are output is the rate at which parts are shipped.

8. The method of claim 6, further comprising receiving a part order, verifying a design file associated with the part order is printable, and measuring a rate at which verified part orders are received, wherein the rate at which part orders are received is the rate at which verified part orders are received.

9. The method of claim 6, further comprising determining a part is to be re-printed by the 3D printers, and generating a set of new part packings that include the part to be re-printed and a plurality of new parts at a rate corresponding to a rate at which new part orders and re-printed part orders are received.

10. The method of claim 6, wherein generating the set of part packings includes:
selecting a set of parts from a list of parts;
generating a first part packing based on the set of parts; and
returning an unused subset of the set of parts that was not included in the first part packing to the list of parts.

11. A non-transitory computer-readable medium comprising instructions that, when executed by a processor, cause the processor to:
retrieve a plurality of parts to be three-dimensionally (3D) printed and an output rate indicative of a rate at which previous 3D printed parts have been output;
select a packing parameter that results in a packing time corresponding to the output rate; and
compute a part packing of the plurality of parts for a print bed according to the packing parameter.

12. The computer-readable medium of claim 11, wherein the instructions cause the processor to retrieve the plurality of parts by retrieving a part packing of the plurality of parts, and compute the part packing by computing an improved part packing of the plurality of parts.

13. The computer-readable medium of claim 11, further comprising instructions that cause the processor to store the part packing in a queue at a location selected based on a priority of the part packing.

14. The computer-readable medium of claim 13, further comprising instructions that cause the processor to determine the priority of the part packing based on a priority of a part of the plurality of parts.

15. The computer-readable medium of claim 11, wherein the instructions cause the processor to compute the part packing in parallel with computations of a plurality of other part packings.
